(19) United States
(12) Patent Application Publication
(10) Pub. No.: US 2008/0046407 A1
(43) Pub. Date: Feb. 21, 2008

(54) Application search interface

(75) Inventors: Mehul Shah, Redmond, WA (US); Ian Carl Legler, Redmond, WA (US); Christian Heydemann, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/505,126

(22) Filed: Aug. 16, 2006

(51) Int. Cl. G06F 17/30

(52) U.S. Cl. 707/3

(57) ABSTRACT

A flexible data search interface is provided. The search interface incorporates multiple tabbed display components, each of which is dedicated to user-entry of a different type of search criteria. When a search is initiated, the search is based on an amalgamation of search criteria entered into each of the multiple tabbed display components. The search interface is implemented within an application to facilitate any of a variety of functions including, but not limited to, information retrieval and task-completion.

### BACKGROUND

Currently, many software applications—both consumer applications and business applications—involve some form of data storage, as well as some form of data categorization and/or data retrieval. For example, an email and scheduling application will sometimes facilitate the storage and retrieval of information about sent and received emails, tasks, appointments, etc. A sales management application will sometimes facilitate the storage and retrieval of information about products, suppliers, purchase orders, etc. A media library application will sometimes facilitate the storage and retrieval of information about archived media (audio/video/pictures/etc.). Of these are just a few of many potential examples.

A common functionality included in applications that support data storage is the ability for the user to search for and retrieve certain items of information. Typically, a user will search for items that match user-supplied criteria. For example, a user might request “all songs by the Beatles,” or “all invoices sent to customer John Doe,” or “all appointments on Wednesday, Jan. 18, 2006.” Of course, these are just a few of many potential examples.

Some searches are performed simply for the purpose of viewing retrieved data and/or data related to the retrieved data. Other searches intended to support completion of a task relative to the retrieved data. In fact, data search functionality is often integrated with other features of a software application. For example, when a user creates an audio play-list, the contents of the play-list may be based on the results of a search process (all songs in play-list are indicated through search as being opera tunes). Or, when a user wants to send an email, the recipients of the email may be based on the results of a search process (e.g., recipients are a set of clients indicated through search as being clients who purchased a particular product during a particular time period).

Different software applications often provide different user experiences in terms of how data is searched. Depending on how a particular instance of search functionality is constructed, a search may not provide a high degree of flexibility or ease of use. For example, an operating system environment might allow a user to search for files but may not be flexible enough for a more complex search (e.g. a search for all files with a “.doc” extension that were opened by a particular user between Jan. 1, 2005 and Dec. 31, 2005).

Further, sometimes there is an inconsistent user experience for different instances of search functionality within the same application. For example, an email application might allow a user to find emails that match certain specific search criteria—but there may be a completely different user experience to find all contacts with the last name “Smith.” Of course, this is but one of many potential examples.

The discussion above is merely provided for general background information and is not intended for use as an aid in determining the scope of the claimed subject matter.

### SUMMARY

A flexible data search interface is provided. The search interface incorporates multiple tabbed display components, each of which is dedicated to user-entry of a different type of search criteria. When a search is initiated, the search is based on an amalgamation of search criteria entered into each of the multiple tabbed display components. The search interface is implemented within an application to facilitate any of a variety of functions including, but not limited to, information retrieval and task-completion.

This Summary is provided to introduce a selection of concepts in a simplified form that are further described below in the Detailed Description. This Summary is not intended to identify key or essential features of the claimed subject matter, nor is it intended for use as an aid in determining the scope of the claimed subject matter. Further, the claimed subject matter is not limited to implementations that solve any or all disadvantages noted in the background.

### BRIEF DESCRIPTION OF THE DRAWINGS

FIG. 1 is a schematic functional architecture diagram related to a search interface.

FIG. 2 is an example of a first tabbed display component of a search interface.

FIG. 3 is an example of a second tabbed display component of the search interface.

FIG. 4 is an example of a third tabbed display component of the search interface.

FIG. 5 is a sample user interface demonstrating how a user might be presented with data exportation options.

FIG. 6 illustrates an example of a suitable computing system environment in which embodiments may be implemented.

FIG. 7 illustrates another example of a suitable computing system environment in which embodiments may be implemented.

FIG. 8 is a block flow diagram illustrating an example of a series of steps associated with a process of re-using search criteria.

### DETAILED DESCRIPTION

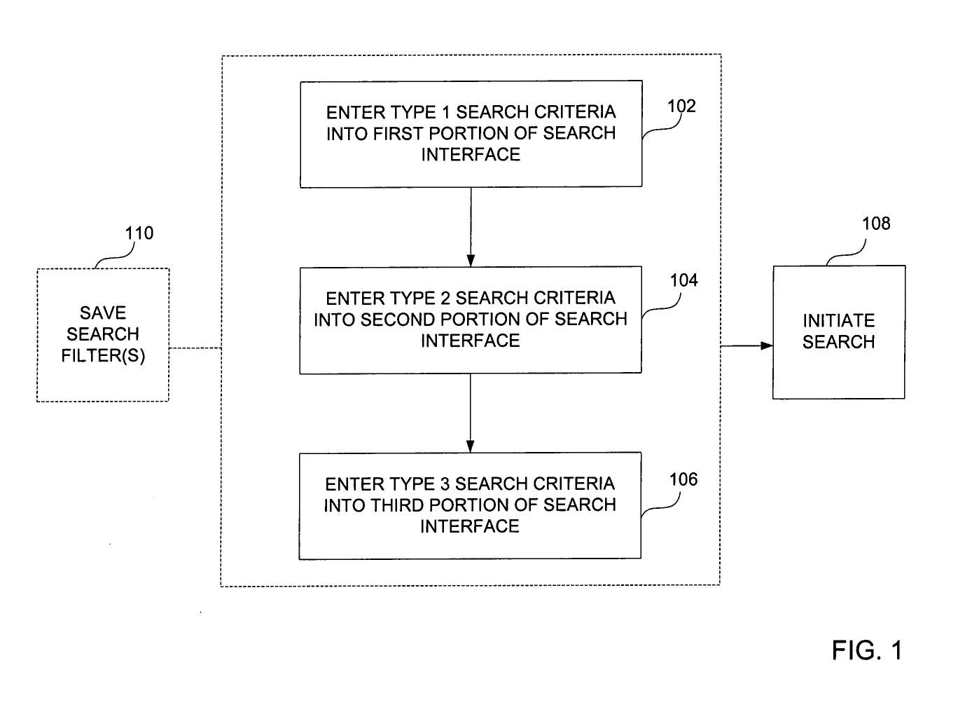

FIG. 1 is a schematic block diagram demonstrating the functional architecture of a search interface. The search interface is illustratively sub-divided into a plurality of different components that are each dedicated to entry of a different type of search criteria. Block 102 represents user-initiated entry of a first type of search criteria into a first component of the search interface. Block 104 represents user-initiated entry of a second type of search criteria into a second component of the search interface. Block 106 represents user-initiated entry of a third type of search criteria into a third component of the search interface.

In one embodiment, the first, second and third components of the search interface are simultaneously displayed to the user as part of an integrated search interface. However, in another embodiment, the first, second and third components of the search interface are displayed one at a time. For example, each component can be implemented as a separate “tab” within a tabbed search interface wherein a user selectively initiates the display of one tab at a time. In yet another embodiment, some components of the search interface are combined into a single display while other components are part of a separate display (e.g, the first and second components are combined within a first selectable tab while the third component is within a separately viewable second tab).

At this point, it should be noted that, while the search interface is sub-divided into separate components for the entry of at least two different types of search criteria, the illustrated third component is optional. Further, the interface can, without departing from the scope of the present invention, be extended to support more than three components (as well as entry of more than three corresponding types of search criteria). Three components are shown in FIG. 1 simply to demonstrate the broad concept of a sub-divided search interface.

A user need not necessarily be required to enter all three types of search criteria in order to initiate a search. In one embodiment, as is generally indicated by block 108 in FIG. 1, the user can initiate a search at any time and, upon initiation, the search will account for all entered search criteria, regardless of whether the entered criteria are of one type, two types or all three types. For example, the system can be configured such that entry of one criteria type is not dependent upon the entry of any other criteria type. That being said, requiring entry of criteria for any or all components of the search interface is within the scope of the present invention and may be desirable in certain implementations.

In one embodiment, there can be implementation of some level of dependency between the components of the search interface. For example, entry of one type of search criteria within a first component of the search interface may require that there first be entry of criteria in one or more different components of the interface. Or, the selections available from which to choose criteria within one component of the interface may be contingent upon a previous selection of criteria in one or more different components of the search interface.

As is indicated by block 110 in FIG. 1, a user can save a record of a search as reflected in any or all of the search interface components. This record can illustratively be recalled as necessary to support re-creation of a search without having to enter in all criteria from scratch. This ability to save a search is an optional feature of the search interface.

The described search interface can be implemented within an application for any purpose without departing from the scope of the present invention. For example, in one embodiment, the search interface is implemented simply as a means to enable a user to access a list of items that meet one or more user-provided search criteria. However, in another embodiment, the search interface is implemented so as to facilitate completion of a task. For example, a user might utilize the search interface to limit the sending of a new email to a select group of recipients. In other words, the user utilizes the search interface as a means to identify a list of recipients that satisfy certain user-defined criteria.

In order to provide a sample context for the search interface functionality described in relation to FIG. 1, a specific example implementation will now be described. However, prior to turning to the example implementation, it should first be pointed out that the scope of the present invention is not limited to any specific implementation described herein. Instead, it is the much broader underlying concepts that form the core of the present invention. In other words, the specific implementation described herein is provided for illustrative purposes only.

Further, it should be noted that specific implementation provided herein relates to a business contact manager (BCM) application environment. Those skilled in the art will appreciate that the present invention could just as easily be applied, without departing from the scope of the present invention, to any application environment that provides functionality to store and retrieve data. The example of a BCM application environment is provided for illustrative purposes only.

Further, in order to provide a detailed context for the example implementation, a few assumptions will be made about the BCM application. The application is illustratively a customer relationship management program targeted toward businesses. The application may stand alone or, alternatively, may be implemented as a plug-in providing features and functionality accessed from within a separate application (e.g., a separate contact manager application intended for a range of users beyond just businesses).

The BCM application illustratively enables users to store and track information about Accounts (e.g., companies or organizations that are customers, Business Contacts (e.g., people with whom interaction occurs, usually associated with an Account), Opportunities (e.g., potential sales orders), Marketing Campaigns (e.g., email, phone pr printed flyer campaigns), Projects (e.g., work orders from customers), Project tasks (e.g., tasks that need to be performed to complete a Project), etc.

Each type of data tracked by the BCM application will illustratively be referred to as an “entity type.” Each instance of an entity type will be referred to as an “item.” For example, a Business Contact or an Account is an entity type, and a Business Contact named John Smith is an item. Each entity type can have a set of attributes (a.k.a., properties). Items can have different values for attributes. For example, a Business Contact entity type illustratively has an attribute called “phone number,” and each business Contact item has a specific value for the phone number attribute. Still further, each attribute is illustratively of a specific type. For example, the attribute “last name” is illustratively of the type “string,” and the attribute “project completion date” is of type “date.”

This terminology and related examples are relevant to the exemplary BCM application environment—but many applications that facilitate the storage and retrieval of data implement a similar design and/or similar semantics. Of course, the exact implementation details and nomenclature of terms will likely vary from one application to another. Regardless of these types of variations, other applications are certainly within the potential scope of the present invention. The scope of the present invention is neither limited to a BCM application nor to any particular data type or field shown or described herein.

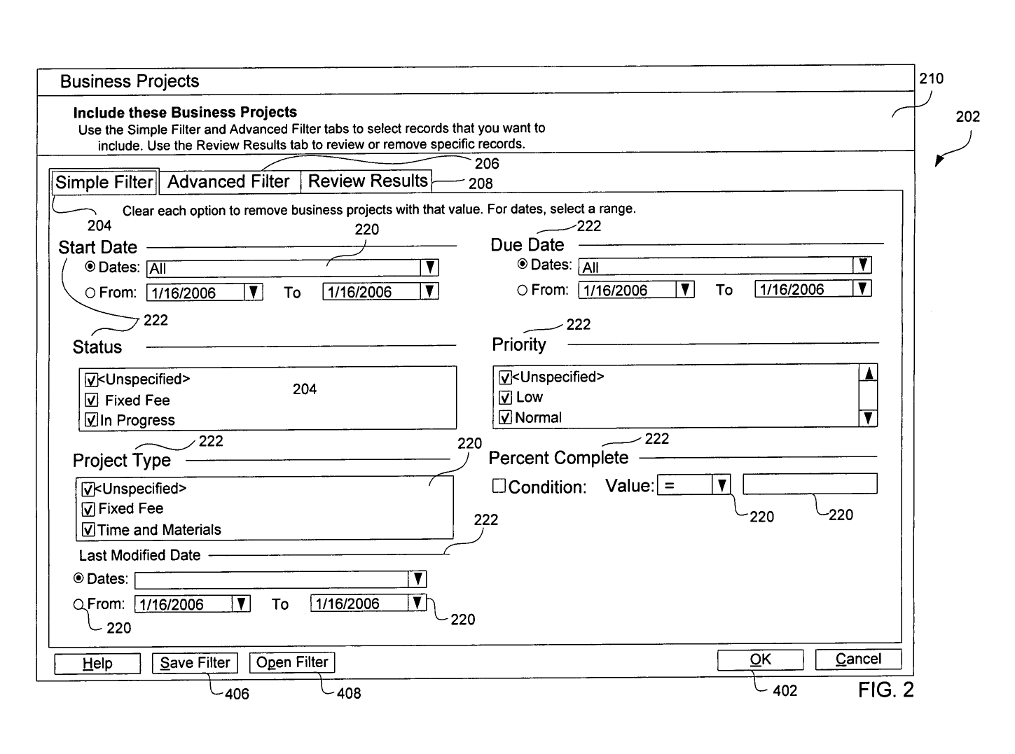

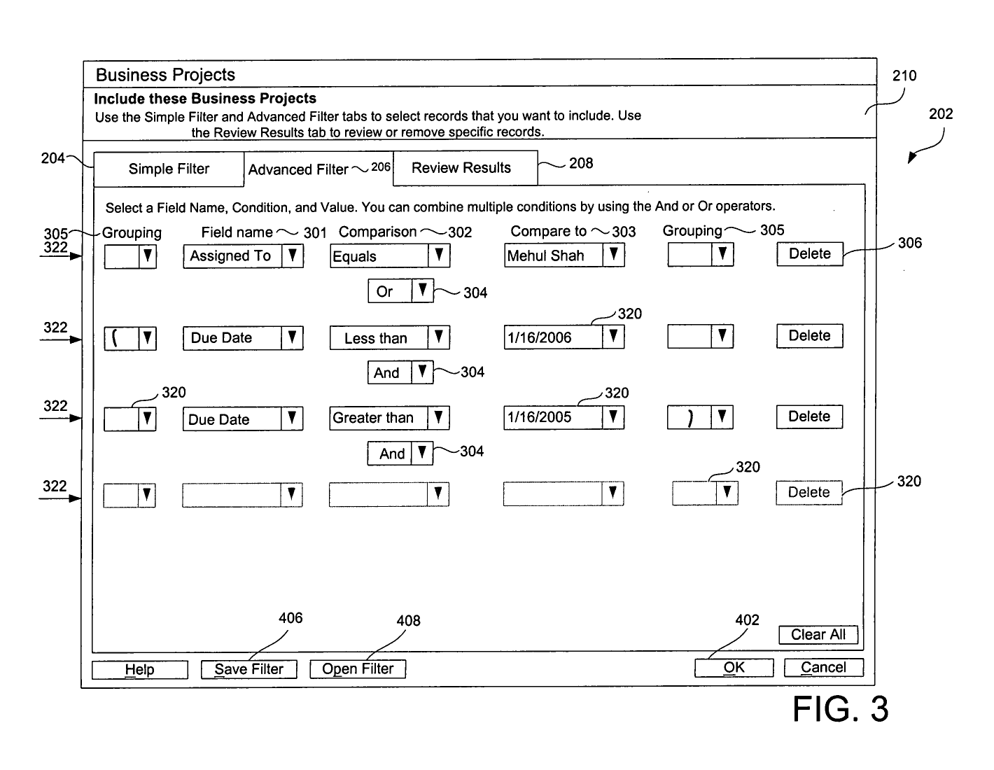

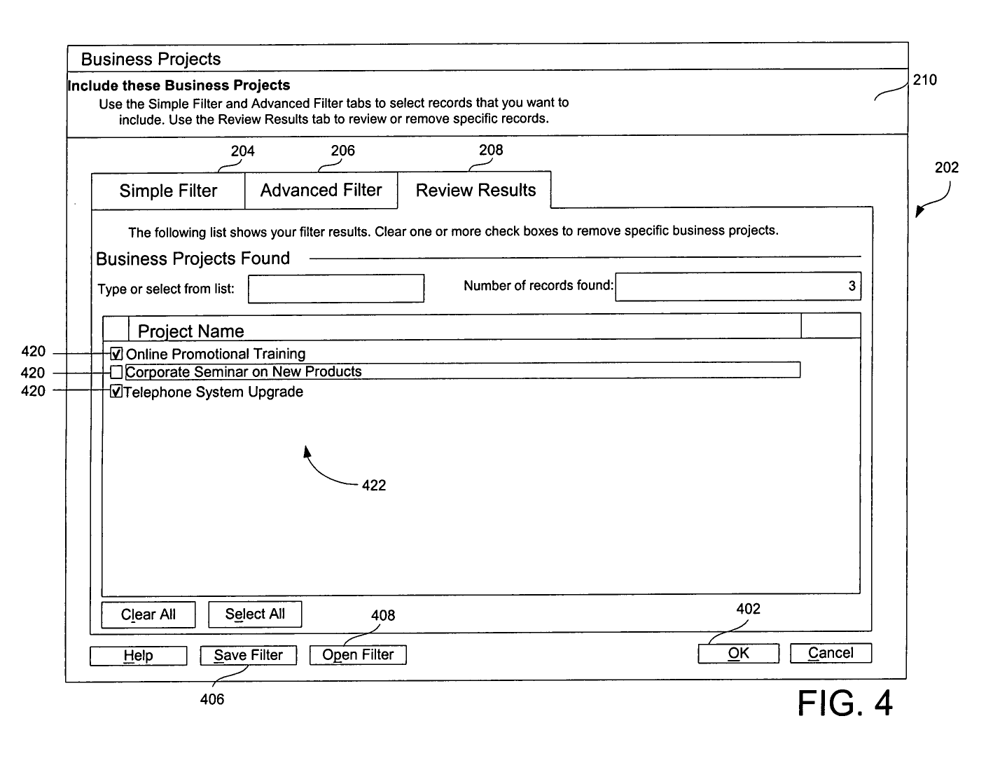

FIGS. 2-4 are example screen shots associated with a search interface 202 implemented by the BCM application. Search interface 202 includes three tabbed display components identified as tab 204, tab 206 and tab 208. The contents of tab 204 are shown in FIG. 2. The contents of tab 206 are shown in FIG. 3. The contents of tab 208 are shown in FIG. 4.

As is suggested by the directions in box 210, a user of the BCM application begins a search process by entering search criteria into tab 204 (simple search filter criteria) and/or tab 206 (more complex search filter criteria such as application of boolean-type operators). Then, the user uses tab 208 to preview and/or modify the search results that are produced following application of the tab 204 and 206 search criteria. From within tab 208, the user can remove and/or add certain search results and/or certain classes of search results.

Thus, search interface 202 provides three tabbed display components—each component enabling the user to provide search criteria using a different type of user interface. Upon initiation of the actual search, the criteria from all three display components are combined (e.g., using an AND statement) and collectively executed to produce the final result set.

With the overall framework of search interface 202 in mind, the present description will now proceed to a more detailed look at each of the three tabbed display components.

FIG. 2 shows tabbed display component 204. Tabbed display component 204 provides a search interface component for entering basic or simple search criteria. More specifically, tabbed display component 204 provides user interface controls 220 (only a representative few have been labeled) that support criteria selection based on frequently used attributes 222 for an entity type being searched (Business Projects in the illustrated example).

Depending upon the entity type being searched, there will be some attributes that are more commonly used than others. For example, when searching for items of the Business Contact entity type, attributes like first name, last name and address are likely to be used relatively often. Attributes like birthday and anniversary date are not likely to be used as often. The most used attributes are likely to be different from one entity type to the next. Thus, the content of tabbed display component 204 is likely to vary depending on the relevant entity type being searched. This is because the UI controls incorporated into display component 204 are selected based on a determination of the most frequently utilized attributes for the entity type being searched.

Further, in one aspect of the present invention, tabbed display component 204 is, to some extent, selectively configurable. Therefore, different instances of tabbed display component 204 may have a different set of controls for searching the same entity type. It follows then that the precise configuration of the tabbed display component 204 shown in FIG. 2, which is illustratively for searching items of a Product entity type, may vary from one application to the next (or even may vary within a single application). What is most desirable in one case may not be most desirable in all circumstances.

For example, the tabbed display component shown in FIG. 2 supports the selection of search criteria for Business Projects based on attributes in the nature of start date, due date, status, project type, priority, etc. For a given application, it might be desirable to also allow a user to specify search criteria based on the attribute “project end date,” which is of type date. A control that is optimized to specify a data (or data range) can be added to tabbed display component 204 to enable project end date as a different basis for searching for items of a Business Project entity type.

Further, for a given application, it may be preferable to enable a user to specify a data range in the form of a start date and an end date. For other applications, it might be preferable to enable a user to choose from a dropdown list that shows “last 7 days,” “last 90 days,” etc. Any of these or other controls can be additionally or alternatively added to tabbed display component 204. Flexibility in terms of control implementation is within the scope of the present invention.

Any of the attribute controls illustrated in FIG. 2 could be alternatively configured. Other attribute controls could be added. Any illustrated attribute control could be removed. In another example, to specify a search criterion associated with the attribute “account financial status,” which can contain one of two values—“past due” or “current”—a drop down user interface control with just those two values can be used to enable the user to make a selection as desired. This is just another of many potential examples of the flexible nature of interface component 204.

In general, it should be emphasized that the attributes for specifying search criteria within tabbed display component 204, as well as the configuration of controls for specifying search criteria within display component 204, need not necessarily be the same from one instance of search interface 202 to the next. Thus, a user's experience in searching for items of a particular entity type in one case (e.g., in one application) may be different than the experience searching for the same items in a different case (e.g., in a different application). The user interface for specifying search criteria within tabbed display component 204 can be adjusted to best address a particular user scenario.

In one embodiment, upon execution of a search in association with search interface 202, the criteria selected within tabbed display component 204 are combined together using an AND statement. Tabbed display component 204 is effective in terms of its ability to enable a user to specify basic search criteria; however, it is limited in terms of flexibility. For example, a user is limited to search criteria that correspond to frequently used attributes. Similarly, given just the functionality of display component 204, it is difficult if not impossible to perform more complex searches such as a search that incorporates complex Boolean logic (e.g., a search for “all Business Contacts located in California, Oregon or Washington that generated sales of less than $10,000 but more than $2000).

FIG. 3 shows tabbed display component 206. Tabbed display component 206 provides a search interface component for adding more advanced search criteria. Display component 206 includes controls 320 (only a representative few have been labeled) for receiving the search parameters. The inflexible nature of tabbed display component 204 is at least partially compensated for by tabbed display component 206. Tabbed display component 206 provides a user interface component configured to enable a user to create additional search limitations in the form of one or more structured query search parameters (including one or more interconnectable comparison statements 322 as shown).

In the illustrated embodiment, which is but one example of an implementation within the scope of the present invention, a user can specify a search criterion by first selecting an attribute from a dropdown list (under column 301 identifies as “field name”). In one embodiment, the dropdown list includes all attributes that are valid for the relevant entity type being searched.

Next, from another dropdown list (under column 302 identified as “comparison”), the user chooses an operator such as “equals,” “not equal to,” “starts with,” “ends with,” “greater than,” “less than,” etc. In one embodiment, only operators that are valid (e.g., that make semantic sense) for the selected attribute type are included in the operator dropdown list. For example, the operator “starts with” makes semantic sense for an attribute of type string or letter, but not for an attribute of type number.

Then, from another dropdown list (under column 303 identified as “compare to”), the user selects a value to compare the selected attribute and operator against. In one embodiment, only values that are valid (e.g., that make semantic sense) are included in the dropdown list. In other words, the values in the compare list are changed dynamically depending upon the type of attribute selected for the criterion and/or the selected operator. For example, if the user selects the attribute “project end date,” which is of type date, then the user interface component for specifying the compare to value is changed to a date-control (e.g., a user interface control optimized for date entry).

Buttons 304 enable the implementation of operations between multiple query statements. The buttons in columns 305 (identified as “grouping”) support the grouping of query statements. The buttons in column 306 support the removal of a logical statement.

FIG. 4 shows tabbed display component 208. Tabbed display component 208 provides a search interface component for manual inclusion/exclusion of items relative to the search results. When the user enters this tab, the application illustratively executes a query based on the search criteria specified in tabs 204 and 206 (e.g., combined using AND statements, etc.). At least a preview 422 of the results of that query (e.g., items that match the search criteria) is then made available in tabbed display component 208.

In one embodiment, by default, all items in the search results shown in tabbed display component 208 are presented with a selection control 420, illustratively a control in a selected state (e.g., a filled in check box or some other indication of a positive selection). The user can uncheck a specific item(s) in order to exclude it from the search results. By doing so, the user is basically updating the collective search query by adding additional criteria that specifies not to include specific items in the search results.

While the illustrated embodiments shows display component 208 as a means for including and excluding actual search results, this should not be considered a limitation on the present invention. Inclusion/exclusion can just as easily be based on displayed characteristics or categories of search results. These and other variations should be considered within the scope of the present invention.

The final search results are illustratively obtained by combining the search criteria specified in all three tabbed display components 204, 206 and 208. Taken together, the three display components provide an easy-to-use and flexible means for specifying search criteria.

In some cases, the first tab (i.e., tabbed display component 204) may be adequate in and of itself for a given user's purposes. This component does provide a simple interface for selecting commonly used search criteria. However, the second tab (i.e., tabbed display component 206) allows additional flexibility through support for structured queries. The third tab (i.e., tabbed display component 208) simply allows for the inclusion/exclusion of specific items. In one embodiment, a user can initiate the compiled search at any time by pushing the “OK” button 402 illustratively shown on all three display components 204, 206 and 208.

It is conceivable that a user might want to use the same search criteria used in one search for a different search. In one aspect of the present invention, the criteria utilized in one search can be saved such that the same criteria can later be recalled and re-asserted. Thus, the process of manually re-entering the search criteria is avoided.

For example, a user that utilizes interface 202 to specify recipients of an email can save the utilized search criteria so that later the same criteria can be re-asserted in order to send a different email to the same recipients (i.e., without having to manually enter the same search criteria). In another example, a user that utilizes interface 202 to generate a report can save the utilized search criteria so that later the same criteria can be re-asserted to generate an updated report (i.e., without having to manually enter the same search criteria). In still another example, a may want to send marketing flyers every six months to all customers who satisfy particular search criteria. In this case, the user can archive the relevant search criteria and re-assert them when it is time to again send flyers (i.e., without having to manually enter the same search criteria).

Each of tabbed display components 204, 206 and 208 includes a “save filter” button 406 and an “open filter” button 208. These buttons are illustratively connected to functionality that enables a user to archive any or all of the search criteria entered in display components 204, 206 and/or 208.

In one embodiment, when the user selects a button 406, a file save dialog is displayed. From the file save dialog, the user can illustratively specify a file to which search criteria will be archived. When the user selects a 408 button, a file open dialog is displayed. From the file open dialog, the user can illustratively choose a file with saved criteria to be opened. Search interface 202 is illustratively updated accordingly. Those skilled in the art will appreciate that search criteria need not necessarily be archived through a file-oriented implementation. Search criteria could, without departing from the scope of the present invention, just as easily be archived and retrieved otherwise, such as through a database, registry or any other implementation.

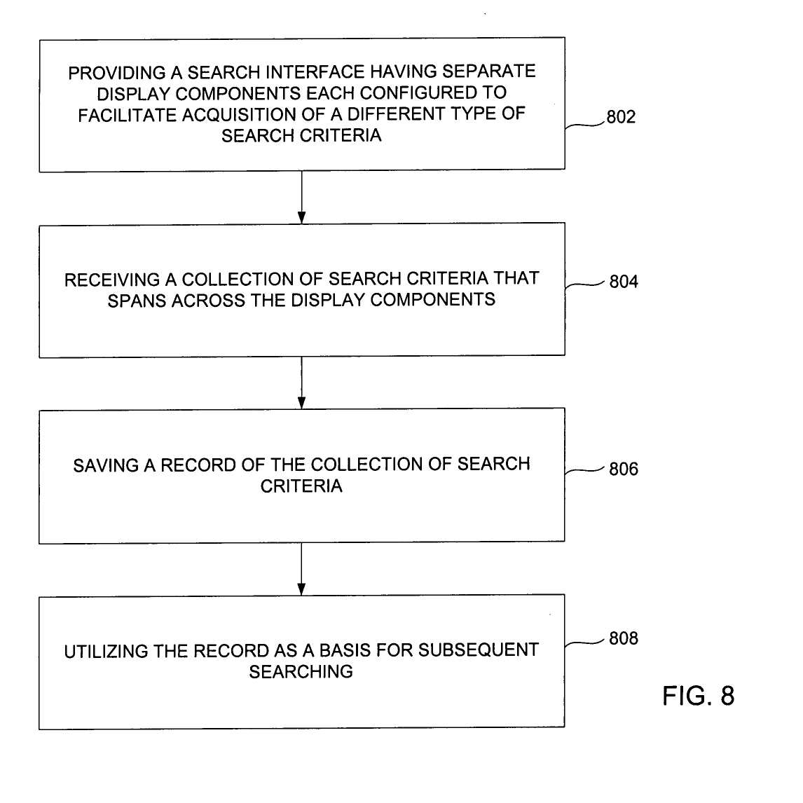

FIG. 8 is a block flow diagram illustrating an example of a series of steps associated with a process of re-using search criteria. In accordance with block 802, a search interface is provided that, similar to interface 202, includes separate display components each configured to facilitate acquisition of a different type of search criteria. In accordance with block 804, a collection of search criteria is received. The received collection spans across multiple display components (e.g., some criteria are from display component 204, some from component 206, and some from component 208). In accordance with block 806, a record related to the collection of search criteria is saved. Finally, in accordance with block 808, the record is utilized subsequently as a basis for creating a search that reflects the same search criteria.

It should be noted that the present invention conceives implementation of the user experience described herein for specifying search criteria (or loading archived search criteria) in any of a broad range of ways within a given application. By implementing the same search interface concepts in multiple scenarios, a desirable level of consistency in user experience is maintained.

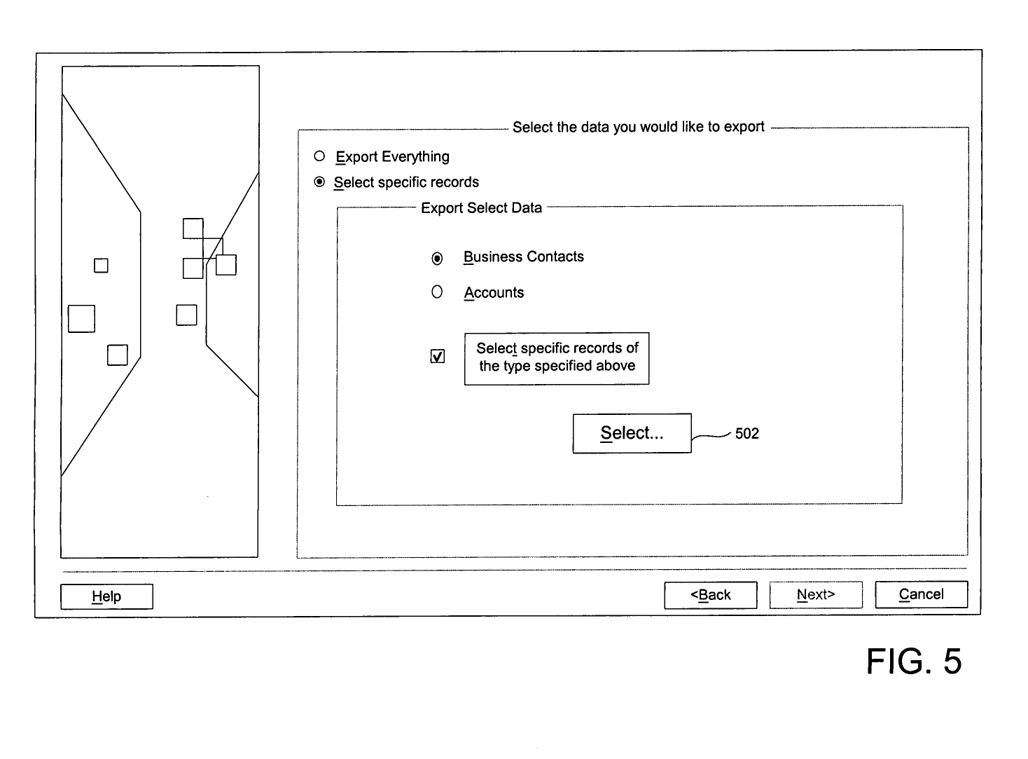

In one example of an implementation a user can illustratively utilize the described search interface 202 to export data to a flat file. This might be desirable, for example, if a user wishes to share data with other users of the application and/or with other computers. The user can illustratively choose to export all data or specific data. When the user chooses to export specific data, the user can designate specific data entity types (e.g., Business Contacts, Accounts, etc.) and/or specific items of those entity types for exportation. Choosing specific items of an entity type simply involves leveraging the search interface 202 to designate specific search or filtering criteria so as to enable a search that leads to identification of items for exportation. The user interface and framework described herein can easily be used for this purpose. FIG. 5 is a sample user interface demonstrating how a user might be presented with data exportation options. Button 502 enables access to a searching interface (e.g., interface 202) that enables specific selection of records related to certain entity types (e.g., Business Contacts and Accounts in the example).

The present invention is not limited to any specific application context or purpose for which search interface 202 can be applied or implemented. In one embodiment, search interface 202 is simply implemented as a means to enable a user to access a list of items that meet one or more user-provided search criteria. For example, a user illustratively might utilize the search interface to request the display of a list of Business Contacts that live in Redmond, Wash. Or, the user might utilize the search interface to request the display of a list of all emails sent between March 1 and April 27 of the current year.

In another embodiment, however, the search interface can just as easily be implemented so as to facilitate completion of a task. For example, a user illustratively might utilize the search interface to limit the sending of a new email to a select group of recipients. In other words, the user utilizes the search interface as a means for searching out recipients that satisfy certain user-defined criteria. Of course, these are just examples of implementations within the scope of the present invention.

Up to this point, to some extent, it has been assumed that the user wants to search for items that meet certain search criteria. In other words, the user knows what entity he or she is looking for. For example, the user knows that he or she is looking for Accounts that meet specific search criteria, or the user is looking for Projects that meet specific criteria. This assumption holds true for many search applications (especially for a BCM application.

However, in some cases the assumption may not be true. For example, consider a search for all emails and documents and instant messages that came from John Smith. For search scenarios such as this one, the user experience discussed in relation to interface 202 can be modified. One option within the scope of the present invention is to combine user interfaces for searching specified entities. For example, when searching for documents and emails, the basic search tab may include both commonly used attributes of documents and commonly used attributes of emails. Similarly, the advanced search tab may allow the inclusion of attributes of emails and documents within the search criteria designation area. This is but another example of a specific implementation within the scope of the present invention.

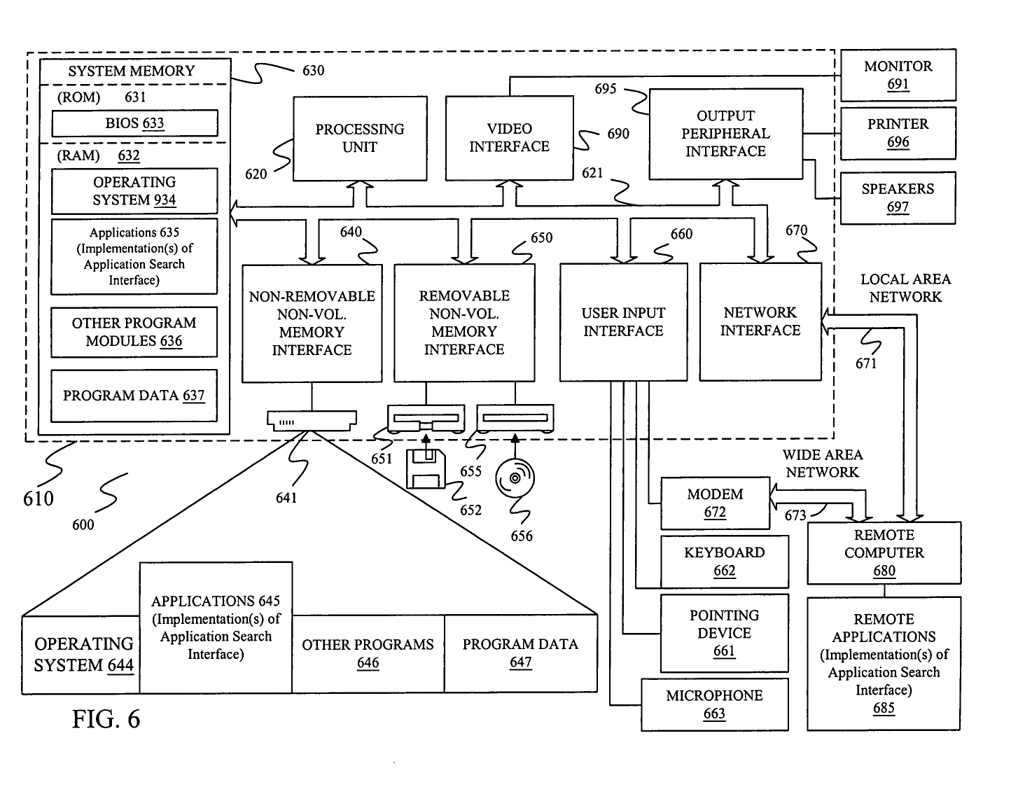

FIG. 6 illustrates an example of a suitable computing system environment 600 in which embodiments may be implemented. The computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary operating environment 600.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments have been described herein in the general context of computer-executable instructions, such as program modules, being executed by a computer. Generally, program modules include routines, programs, objects, components, data structures, etc. that perform particular tasks or implement particular abstract data types. Embodiments can be practiced in distributed computing environments where tasks are performed by remote processing devices that are linked through a communications network. In a distributed computing environment, program modules can be located on both (or either) local and remote computer storage media including memory storage devices.

With reference to FIG. 6, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637. Programs 635 are illustrated as being configured to support one or more implementation of the application search interface embodiments as described herein. This need not necessarily be the case for any or all of the programs. Further, programs 636 and/or operating system 634 could just as easily also or alternatively be configured to support one or more implementation of the search interface technology.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

Programs 645 are illustrated as being configured to support one or more implementation of the application search interface embodiments as described herein. This need not necessarily be the case for any or all of the programs. Further, programs 646 and/or operating system 644 could just as easily also or alternatively be configured to support one or more implementation of the search interface technology.

A user may enter commands and information into the computer 610 through input devices such as a keyboard 662, a microphone 663, and a pointing device 661, such as a mouse, trackball or touch pad. Other input devices (not shown) may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user-input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between the computers may be used. Programs 685 are illustrated as being configured to support command-oriented advertising/searching as described herein. This need not necessarily be the case for any or all of the programs.

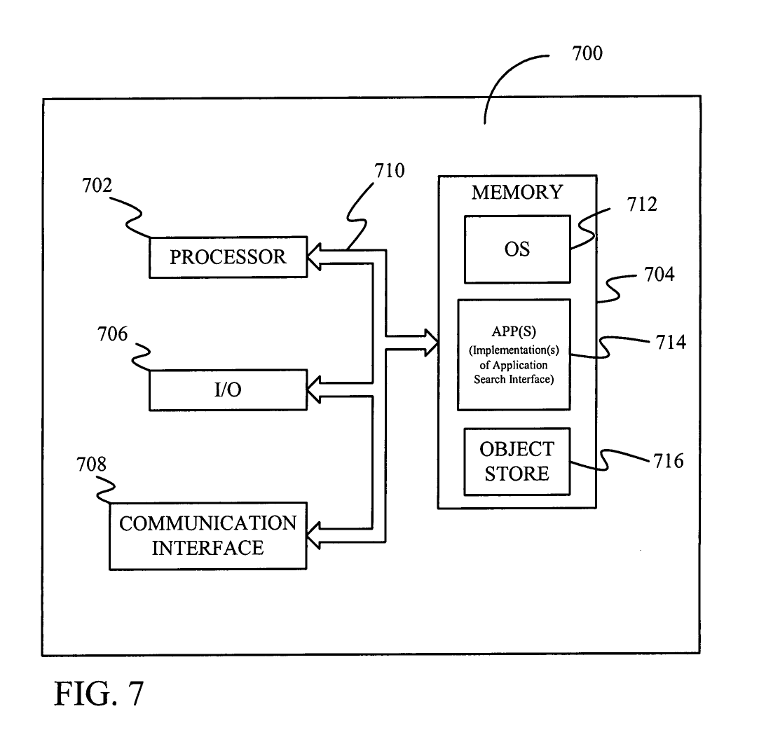

FIG. 7 is a block diagram of a mobile device 700, which is another exemplary computing environment. Mobile device 700 includes a microprocessor 702, memory 704, input/output (I/O) components 706, and a communication interface 708 for communicating with remote computers or other mobile devices. In one embodiment, the afore-mentioned components are coupled for communication with one another over a suitable bus 710.

Memory 704 is implemented as non-volatile electronic memory such as random access memory (RAM) with a battery back-up module (not shown) such that information stored in memory 704 is not lost when the general power to mobile device 700 is shut down. A portion of memory 704 is illustratively allocated as addressable memory for program execution, while another portion of memory 704 is illustratively used for storage, such as to simulate storage on a disk drive.

Memory 704 includes an operating system 712, application programs 714 as well as an object store 716. Programs 714 are illustrated as being configured to support one or more implementation of the application search interface embodiments as described herein. This need not necessarily be the case for any or all of the programs. Further, other programs and/or operating system 712 could just as easily also or alternatively be configured to support one or more implementation of the search interface technology.

During operation, operating system 712 is illustratively executed by processor 702 from memory 704. Operating system 712 is illustratively designed for mobile devices, and implements database features that can be utilized by applications 714 through a set of exposed application programming interfaces and methods. The objects in object store 716 are maintained by applications 714 and operating system 712, at least partially in response to calls to the exposed application programming interfaces and methods.

Communication interface 708 represents numerous devices and technologies that allow mobile device 700 to send and receive information. The devices include wired and wireless modems, satellite receivers and broadcast tuners to name a few. Mobile device 700 can also be directly connected to a computer to exchange data therewith. In such cases, communication interface 708 can be an infrared transceiver or a serial or parallel communication connection, all of which are capable of transmitting streaming information.

Input/output components 706 include a variety of input devices such as a touch-sensitive screen, buttons, rollers, and a microphone as well as a variety of output devices including an audio generator, a vibrating device, and a display. The devices listed above are by way of example and need not all be present on mobile device 700. In addition, other input/output devices may be attached to or found with mobile device 700.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A data search interface, comprising:
a first display component having a first set of controls for receiving a first set of search criteria; and
a second display component configured to display a preview of a result set containing data items that will be returned upon processing of the first set of criteria, wherein the second display is further configured to support a user-initiated elimination of at least one data item from the result set.

2. The data search interface of claim 1, wherein the first display component is implemented as a first tabbed window and the second display component is implemented as a second tabbed window.

3. The data search interface of claim 2, wherein the data search interface is configured such that the first and second set of controls are not simultaneously displayed.

4. The data search interface of claim 1, wherein the first set of controls is configured to facilitate entry of search criteria categorized by attributes of at least one entity type.

5. The data search interface of claim 4, wherein the first display component provides a plurality of controls distributed relative to a listing of attributes associated with an entity type.

6. The data search interface of claim 1, wherein the first set of controls is configured to facilitate entry of search criteria in the form of one or more comparison statements.

7. The data search interface of claim 1 further comprising:
a third display component having a second set of controls for receiving a second set of search criteria; and
wherein said preview is a preview of a result set containing data items that will be returned upon execution of the first set of criteria in combination with an execution of the second set of criteria.

8. The data search interface of claim 7 further comprising means for switching between display of the first, second and third display components prior to generation of a result set other than said preview of the result set.

9. The data search interface of claim 1 further comprising a mechanism for saving a record of the first set of search criteria as received by the first of controls.

10. The data search interface of claim 9, wherein the mechanism includes a save button positioned on at least one of the first and second display components.

11. The data search interface of claim 9, wherein the interface is implemented within an application as a means for identifying a collection of items in the context of which an application task is to be completed.

12. A computer-implemented method of formulating a search query, the method comprising:
providing a search interface that includes a plurality of display components each configured to facilitate acquisition of a different type of search criteria;
receiving a collection of search criteria originating from at least two different display components;
saving a record indicative of the collection of search criteria; and
utilizing the record as a basis for formulating a search query.

13. The method of claim 12, wherein providing a search interface comprises providing a search interface that includes multiple separate tabbed display components.

14. The method of claim 12, wherein providing a search interface comprises providing a search interface that includes a display component configured to facilitate entry of search criteria categorized by attributes of at least one entity type.

15. The method of claim 12, wherein providing a search interface comprises providing a search interface that includes a display component that includes a plurality of controls distributed relative to a listing of attributes associated with an entity type.

16. The method of claim 12, wherein providing a search interface comprises providing a search interface that includes a display component configured to facilitate entry of search criteria in the form of one or more comparison statements.

17. A data search interface comprising a first display component and a second display component, wherein the data search interface is configured to support generation of a search query based on an amalgamation of search criteria received from both the first and second display components.

18. The data search interface of claim 17, wherein the second display component is configured to support a specific exclusion of a search result that has been pre-determined to be within the scope of a search criteria associated with the first display component.

19. The data search interface of claim 17, wherein the first display component provides a plurality of controls distributed relative to a listing of attributes associated with an entity type.

20. The data search interface of claim 17, wherein the first set of controls is configured to facilitate entry of search criteria in the form of one or more comparison statements.
